(19) United States
(12) Patent Application Publication
(10) Pub. No.: US 2008/0247122 A1
(43) Pub. Date: Oct. 9, 2008

(54) CAPACITOR WITH IMPROVED VOLUMETRIC EFFICIENCY AND REDUCED COST

(75) Inventors: PAVEL VAISMAN, BE'ER-SHEVA (IL); ALEX EIDELMAN, BE'ER-SHEVA (IL); EVGENY PETUHOV, BE'ER-SHEVA (IL)

Correspondence Address: MCKEE, VOORHEES & SEASE, P.L.C., 801 GRAND AVENUE, SUITE 3200, DES MOINES, IA, 50309-2721, US

(73) Assignee: VISHAY SPRAGUE, INC., Sanford, ME (US)

(21) Appl. No.: 11/747,335

(22) Filed: May 11, 2007

Related U.S. Application Data
(60) Provisional application No. 60/910,556, filed on Apr. 6, 2007.

(51) Int. Cl. H01G 4/228; H01G 9/08; H01G 9/15

(52) U.S. Cl. 361/533; 29/25.03; 361/535; 361/540

(57) ABSTRACT

A surface mount capacitor is provided. The surface mount capacitor includes a capacitive element including an anode and a cathode, the anode having an exposed portion, an encapsulation material partially surrounding the capacitive element, a non-conductive substrate in contact with the encapsulation material, an anode termination connected to the non-conductive substrate, a cathode termination connected to the non-conductive substrate, and a first conductive path between the exposed portion of the anode and the anode termination comprising a first external conductive connection on a first external surface of the capacitor. The capacitor may also include a second conductive path between the cathode and the cathode termination. The second conductive path includes a second external conductive connection on a second external surface of the capacitor. The second conductive path may further include a conductive adhesive between the cathode and the second external conductive connection.

### CROSS-REFERENCE TO RELATED APPLICATIONS

This application claims priority under 35 U.S.C. §119 of a provisional application Ser. No. 60/910,556 filed Apr. 6, 2007, which application is hereby incorporated by reference in its entirety.

### BACKGROUND OF THE INVENTION

The present invention relates to surface mount capacitors and, in particular to surface mount capacitors having improved volumetric efficiency and reduced cost.

Demand has steadily increased for surface mount capacitors. They are useful for numerous and widely-varying applications and functions. For example, they are useful for maintaining signal integrity and high speed delivery of charge in electrical and electronic components or devices. They are also particularly useful in switching functions. They are useful for bulk decoupling capabilities to smooth transient requirements seen by a power source.

The types and configurations presently available are numerous. Most have some type of capacitive element inside an enclosure or case. External conductive connections or terminations are electrically connected to the internal capacitive element. The capacitor assembly can be placed upon a circuit board and connected to the circuit through the terminations.

Different capacitive element configurations produce different capacitive performance. The nature of the capacitive elements can determine their size. For example, some need to handle high voltage and, to do so, must use relatively large capacitive elements. This results in a relatively large case size.

However, many times the size of electrical components is important in circuit design. This brings what is called “volumetric efficiency” into play. Volumetric efficiency is known in the art to refer to capacitance per unit volume. Two aspects of volumetric efficiency relative to the present invention are as follows.

First, there is volumetric efficiency of the capacitive element itself. Some materials have a higher capacitance performance than others for the same size or volume. A good example is tantalum. It is well-known that a solid tantalum capacitive element exhibits more capacitive performance than aluminum for the same volume.

Second, there is volumetric efficiency of the entire capacitor; namely the capacitive element(s), case, and terminations. The case defines a certain volume. If the volume of the capacitive element inside the case is small relative to the total volume of the case, the volumetric efficiency of the entire capacitor is normally lower than if the volume of the capacitive element is large relative to case size.

If room on the circuit board for the capacitor is not a concern, volumetric efficiency may not be a concern. However, as can be appreciated, volumetric efficiency becomes increasingly important as space for the capacitor becomes more limited. As increasing miniaturization occurs for a wide variety of electronic and electrical devices, demand increases for increasingly smaller surface mount capacitors.

Capacitors can represent the highest part count in many circuits. Therefore, a reduction in case size (and thus volume) of capacitors, while maintaining (or even increasing) capacitive performance, is an important present need in the art. Circuit designers need to be able to specify a certain case size for capacitors to allow them to fit on a circuit board with the other components needed for the electrical or electronic device.

However, it is difficult to simultaneously meet increasing capacitive performance needs and at the same time have a very small package or case size. Minimizing size while maintaining or improving capacitor performance is a challenging task. Additionally, independent of case size, there is always a need to improve the performance of, and volumetric efficiency of, capacitive elements and capacitor assemblies.

One way to improve volumetric efficiency is to use a high performing material, for example tantalum (Ta), Niobium (Nb), or Niobium Oxide (NbO), for the anode material. Solid core or pellet surface mount capacitors of this general type are well known in the art. Examples can be seen at U.S. Pat. Nos. 6,380,577 and 6,238,444, incorporated by reference herein. In those patents, the solid interior core (sometimes called an anode body, slug or pellet) is primarily Ta. The tantalum anode body is usually sintered. A wire is commonly formed in the anode body in one of two ways; (a) “embedded”, meaning the wire (also can be Tantalum) is covered with Tantalum powder during a pressing process or (b) “welded” meaning after the pellet is pressed and sintered, the wire is welded to the Ta slug. The other end extends outside the slug. The capacitor dielectric material is made by anodic oxidation of the anode material to form an oxide layer over the surface of the anode body (e.g. Ta→Ta₂O₅). If the anode body is Nb the oxidation is Nb→Nb₂O₅; if NbO, the oxidation is NbO→Nb₂O₅. A capacitor cathode is commonly formed by coating the dielectric layer with a solid electrolyte layer (e.g. of MnO₂) and a conductive polymer, and later covered with graphite and silver for better conductivity and improved mechanical strength. Anode and cathode terminations can be connected to the free end of the Ta wire and the outer electrolyte surface coating of the Ta pellet, respectively, and all these components can then be encapsulated within a case (e.g. by molding plastic around the components), leaving only outer surface(s) of the anode and cathode terminations exposed on the exterior of the case for, e.g., surface mounting.

For example, prior art configurations result in a substantial volume of encapsulating material to be used to encase pellets and sufficient space must be allowed for electrical connections from the anode and cathode to the terminations. This limits the size of pellet that can be used.

U.S. Pat. No. 7,161,797 to Vaisman et al., herein incorporated by reference in its entirety, discloses a surface mount capacitor can be constructed with improved volumetric efficiency between an anode associated with the pellet and an anode termination external of the case. The external connection allows improved volumetric efficiency by freeing up space. FIG. 1 illustrates the capacitor of Vaisman et al. The capacitor 10 include an outer case or encapsulating material 6 of conventional plastic material. Capacitor 10 is elongated along a longitudinal axis. Its bottom surface includes anode termination 3 and a cathode termination 2. The termination are made of conventional material such as copper, silver, or nickel alloys. Terminations 2 and 3 are at opposite ends of the capacitor. Inside case 6 is a tantalum anode body, pellet or slug 1. A tantalum wire 9 is connected to the pellet 1 and extends out one end of the pellet 1 inside the case 6. An electrical conductive path 7 is added between the wire 9 and the anode termination 3. An electrically conductive adhesive 4 is used between the pellet 1 and the cathode termination 2. An insulating adhesive 5 supports one end of the pellet 1, separating the pellet 1 from the anode termination 3. In manufacturing, an electrically conductive (metal plate) substrate or lead frame is pre-manufactured to include rows and columns of pre-formed adjacent anode termination 3 and cathode termination 2 pairs.

Despite the advantage in volumetric efficiency the capacitor of FIG. 1 may have over alternative designs, problems remain. In particular, the cost of the metal substrate or lead frame material used for the anode and cathode terminations is high when compared to the overall price of the capacitor. The metal substrate or lead frame material is typically copper. It would be desirable to reduce capacitor cost by reducing the costs associated with the lead frame material.

### BRIEF SUMMARY OF THE INVENTION

It is therefore a principal object, feature, aspect, or advantage of the present invention to provide an apparatus and method which improves upon the state of the art.

Other objects, features, or advantages of the invention include an apparatus or method which:
a. improves volume utilization or volumetric efficiency;
b. is efficient and economical, including for small case size mass production;
c. eliminates the need for a lead frame and the costs associated with using a lead frame.

These and/or other objects, features, aspects, and advantages of the present invention will become apparent from the accompanying specification and claims.

According to one aspect of the invention a surface mount capacitor is provided. The surface mount capacitor includes a capacitive element including an anode and a cathode, the anode having an exposed portion, an encapsulation material partially surrounding the capacitive element, a non-conductive substrate in contact with the encapsulation material, an anode termination connected to the non-conductive substrate, a cathode termination connected to the non-conductive substrate, and a first conductive path between the exposed portion of the anode and the anode termination comprising a first external conductive connection on a first external surface of the capacitor. The capacitor may also include a second conductive path between the cathode and the cathode termination. The second conductive path includes a second external conductive connection on a second external surface of the capacitor. The second conductive path may further include a conductive adhesive between the cathode and the second external conductive connection.

According to another aspect of the present invention, a surface mount capacitor is provided. The surface mount capacitor includes a capacitive element including an anode and a cathode, an encapsulation material forming a case around the capacitive element except for an exposed portion of the anode, and an electrically conductive planar substrate comprising anode and cathode terminations having surface mounting portions on a single exterior side of the case and to which the capacitive element is mounted. There is a first conductive path between the exposed portion of the anode and the anode termination. The first conductive path includes a first external conductive connection on a first external surface of the case. There is a second conductive path between the cathode and the cathode termination. The second conductive path includes a second external conductive connection on a second external surface of the case. The second conductive path between the cathode and the cathode termination further may further include a conductive adhesive between the cathode and the second external conductive connection. The surface mount capacitor may further include a non-conductive substrate, the anode and cathode terminations operatively connected to the non-conductive substrate, the non-conductive substrate separating the encapsulation material from the anode and cathode terminations.

According to another aspect of the present invention, an electrical circuit board is provided. The electrically circuit board includes an electrical circuit having at least one surface mount capacitor. Each of the at least on surface mount capacitor includes a capacitive element including an anode and a cathode, an encapsulation material forming a case around the capacitive element except for an exposed portion of the anode, an electrically conductive planar substrate comprising anode and cathode terminations having surface mounting portions on a single exterior side of the case and to which the capacitive element is mounted, a first conductive path between the exposed portion of the anode and the anode termination having a first external conductive connection on a first external surface of the case, and a second conductive path between the cathode and the cathode termination having a second external conductive connection on a second external surface of the case.

According to another aspect of the present invention, an electrical or electronic device includes: a) a housing and a user interface; b) an electrical circuit board in the housing including at least one surface mount capacitor; c) the surface mount capacitor having a capacitive element including an anode and a cathode, an encapsulation material forming a case around the capacitive element except for an exposed portion of the anode, an electrically conductive planar substrate comprising anode and cathode terminations having surface mounting portions on a single exterior side of the case and to which the capacitive element is mounted, a first conductive path between the exposed portion of the anode and the anode termination including a first external conductive connection on a first external surface of the case, and a second conductive path between the cathode and the cathode termination including a second external conductive connection on a second external surface of the case.

According to another aspect of the present invention, a method of manufacturing a surface mount capacitor is provided. The method includes substantially encapsulating a capacitive element including an anode and a cathode while leaving an exposed portion of the anode, forming a cathode termination and an anode termination on an insulating substrate separated from the capacitive element, forming a first conductive path between the exposed portion of the anode and an anode termination, the first conductive path comprising a first external conductive connection on a first external surface of the capacitor, and forming a second conductive path between the cathode and a cathode termination, the second conductive path having a second external conductive connection on a second external surface of the capacitor.

### BRIEF DESCRIPTION OF THE DRAWINGS

FIG. 1 is a cross-sectional view of a prior art capacitor such as that disclosed in U.S. Pat. No. 7,161,797 to Vaisman et al.

FIG. 2 is cross-sectional view of one embodiment of a capacitor of the present invention.

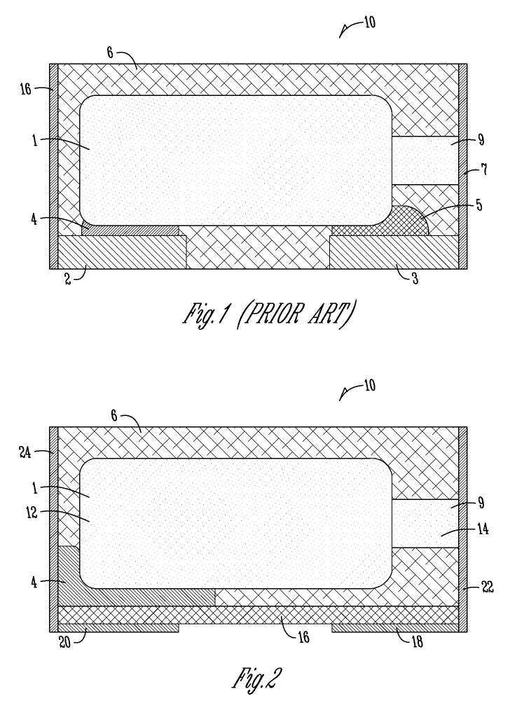

### DETAILED DESCRIPTION OF THE PREFERRED EMBODIMENT

For a better understanding of the present invention, an exemplary embodiment will now be described in detail. Frequent reference will be taken to the above-described drawings. Reference numerals and/or letters will be used to indicate certain parts or locations in the drawings. The same reference numerals and/or letters will be used to indicate the same parts or locations throughout the drawings unless otherwise indicated.

The context of this exemplary embodiment is a surface mount capacitor having single-sided terminations-anode and cathode terminations are both in generally the same plane on only one side (here the bottom surface mount side) of the device. In particular, this exemplary embodiment is a surface mount molded solid electrolyte tantalum capacitor having anode and cathode terminations on the bottom plane of the casing. The casing size of this example, case size 0603 (such as is known in the art), is relatively small (approximate dimensions: length of 1.6 (±0.1) mm; width of 0.8 (±0.1) mm; and height of 0.8 (±0.1) mm). This represents a case volume of roughly a little over 1 mm³. Examples of other relatively small case sizes are 0402 and 0805. However, the invention is not limited to any particular case size or any particular material or configuration of capacitive element inside the case. In fact, the invention can be scaled up or down as desired. One of the advantages or features of the invention is that ability—namely, the ability to apply this to a variety of different capacitor package sizes while using the same concepts and manufacturing techniques.

By reference to FIG. 2, an exemplary capacitor 10, according to one aspect of the present invention, is illustrated. Capacitor 10 includes an outer case or encapsulating material 6 of a conventional encapsulating material such as, but not limited to, plastic. The case size of case may be a 0402, 0603, 0805, or other standard or otherwise desirable size.

Capacitor 10 includes a capacitive element 1 including an anode 14 and a cathode 12. The anode has an exposed portion 9. There is an encapsulation material 6 at least partially surrounding the capacitive element 1. A non-conductive or insulating substrate 16 is shown which is in contact with the encapsulation material 6. An anode termination 18 and a cathode termination 20 are connected to the non-conductive substrate 16. There is a first conductive path between the exposed portion of the anode 9 and the anode termination 18. The first conductive path includes a first external conductive connection 22 on a first external surface of the capacitor. There is a second conductive path between the cathode 12 and the cathode termination 20 which includes a second external conductive connection 24 on a second external surface of the capacitor 10. The second conductive path between the cathode 12 and the cathode termination 20 further includes a conductive adhesive 4 between the cathode 12 and the second external conductive connection 24.

The resulting capacitor 10 uses external connections 22, 24 to its terminations instead of having internal connections which preserves space for the capacitive element 1 thereby allowing for improved volumetric efficiency. In addition, the resulting capacitor 10 uses the non-conductive substrate 16 instead of a conductive lead frame. Lead frames are typically made of highly conductive metals such as copper which can account for a significant portion of the cost of the capacitor. Instead of using pre-formed lead forms, the terminations may be formed through other processes, such as, but not limited to metal deposition or plating processes.

It will be appreciated that the foregoing exemplary embodiment and exemplary manufacturing method are but one way the invention can be practiced. They are presented for illustrative purposes only and not by way of limitation. Variations obvious to those skilled in the art are included with the invention.

For example, the invention is applicable to a variety of package or case sizes. It can be scaled up or down according to need. Examples of package sizes include 0402, 0603, 0805, and bigger sizes.

Capacitor 10 can be manufactured to at least standard tolerances in a variety of capacitance and other ratings, including relatively high power applications. It could be utilized for low profile conformal surface mount applications with high volumetric efficiency for energy storage, filtering, and by-pass. It could be utilized in microprocessor based systems. It can be advantageous for other higher frequency, single sided termination applications. These are but a few application examples.

The invention can be utilized for use with electrical or electronic devices of almost any type. Consumer, medical, and communication products are prime candidates for such capacitors. RF applications are also candidates. Some examples in communication and consumer segments are cell phones, personal digital assistants, MP3 players or other audio or video players, digital cameras, and hand-held gaming devices. Medical field applications are also of high potential. The fields of application is not limited.

The precise type of capacitor can also vary. In the exemplary embodiment, capacitor 10 is a chip capacitor of the type having a tantalum slug or pellet which is sintered, formed and impregnated with manganese dioxide or conductive polymer. Wire 9 is tantalum wire. The outer surface of each pellet is covered with a cured silver paste that serves as a cathode electrode. However, other materials for the capacitive component can be used. The invention is not limited to tantalum pellets or slugs. Other materials, forms, and configurations for the capacitive component, as well as for the case 6 or other aspects of the capacitor are possible.

Each capacitor can be surface mounted according to known methodologies. The applicability of these capacitors extends to all uses of surface mount capacitors. A primary benefit of capacitor 10 is the ability to have either smaller size for the same or greater capacitance or have a greater amount of capacitance for a similar sized case and without using a lead frame in manufacturing.

What is claimed is:

1. A surface mount capacitor, comprising:
a capacitive element including an anode and a cathode, the anode having an exposed portion;
an encapsulation material partially surrounding the capacitive element;
a non-conductive substrate in contact with the encapsulation material;
an anode termination connected to the non-conductive substrate;
a cathode termination connected to the non-conductive substrate;
a first conductive path between the exposed portion of the anode and the anode termination comprising a first external conductive connection on a first external surface of the capacitor.
a second conductive path between the cathode and the cathode termination comprising a second external conductive connection on a second external surface of the capacitor.

2. The surface mount capacitor of claim 1 wherein the second conductive path between the cathode and the cathode termination further comprises a conductive adhesive between the cathode and the second external conductive connection.

3. The surface mount capacitor of claim 1 wherein the first external surface of the capacitor and the second external surface of the capacitor are on opposite ends of the capacitor.

4. The surface mount capacitor of claim 1 wherein the capacitor includes a top side, a bottom side, a first side between the top and bottom sides, a second side between the top and bottom sides, a first end side and a second end side and wherein the first external surface of the capacitor is on the first side and the second external surface of the capacitor is on the second side.

5. The capacitor of claim 1 wherein the first external conductive connection and the second external conductive connection are plated with an electrically conductive plating material.

6. The capacitor of claim 1 wherein the capacitive element comprises a solid body.

7. The capacitor of claim 6 wherein the solid body is a pellet.

8. The capacitor of claim 7 wherein the pellet comprises tantalum, niobium, or niobium oxide.

9. The capacitor of claim 8 wherein the anode comprises the pellet and a wire having a portion embedded in or welded to the pellet and a portion outside of the pellet, and a dielectric layer formed by oxidation of anode material, and the cathode comprises an electrolyte layer on an exterior of the pellet.

10. The capacitor of claim 1 wherein the first external surface of the capacitor is generally orthogonal to the anode termination and the second external surface of the capacitor is generally orthogonal to the cathode termination.

11. A surface mount capacitor comprising:
a) a capacitive element including an anode and a cathode;
b) an encapsulation material forming a case around the capacitive element except for an exposed portion of the anode;
c) an electrically conductive planar substrate comprising anode and cathode terminations having surface mounting portions on a single exterior side of the case and to which the capacitive element is mounted;
d) a first conductive path between the exposed portion of the anode and the anode termination comprising a first external conductive connection on a first external surface of the case;
e) a second conductive path between the cathode and the cathode termination comprising a second external conductive connection on a second external surface of the case.

12. The surface mount capacitor of claim 11 wherein the second conductive path between the cathode and the cathode termination further comprises a conductive adhesive between the cathode and the second external conductive connection.

13. The surface mount capacitor of claim 11 further comprising a non-conductive substrate, the anode and cathode terminations operatively connected to the non-conductive substrate, the non-conductive substrate separating the encapsulation material from the anode and cathode terminations.

14. The surface mount capacitor of claim 11 wherein the first external surface of the capacitor and the second external surface of the capacitor are on opposite ends of the capacitor.

15. The surface mount capacitor of claim 11 wherein the case of the capacitor includes a top side, a bottom side, a first side between the top and bottom sides, a second side between the top and bottom sides, a first end side and a second end side and wherein the first external surface of the case is on the first side and the second external surface of the case is on the second side.

16. The capacitor of claim 11 wherein the first external conductive connection and the second external conductive connection are plated with an electrically conductive plating material.

17. The capacitor of claim 11 wherein the capacitive element comprises a solid body.

18. The capacitor of claim 17 wherein the solid body is a pellet.

19. The capacitor of claim 18 wherein the pellet comprises tantalum, niobium, or niobium oxide.

20. The capacitor of claim 18 wherein the anode comprises the pellet and a wire having a portion embedded in or welded to the pellet and a portion outside of the pellet, and a dielectric layer formed by oxidation of anode material, and the cathode comprises an electrolyte layer on an exterior of the pellet.

21. The capacitor of claim 1 1 wherein the first external surface of the capacitor is generally orthogonal to the anode termination and the second external surface of the capacitor is generally orthogonal to the cathode termination.

22. An electrical circuit board comprising:
a) an electrical circuit board;
b) an electrical circuit on the circuit board including at least one surface mount capacitor;
c) each of the at least on surface mount capacitor comprising a capacitive element including an anode and a cathode, an encapsulation material forming a case around the capacitive element except for an exposed portion of the anode, an electrically conductive planar substrate comprising anode and cathode terminations having surface mounting portions on a single exterior side of the case and to which the capacitive element is mounted, a first conductive path between the exposed portion of the anode and the anode termination comprising a first external conductive connection on a first external surface of the case, and a second conductive path between the cathode and the cathode termination comprising a second external conductive connection on a second external surface of the case.

23. The surface mount capacitor of claim 11 further comprising a non-conductive substrate, the anode and cathode terminations operatively connected to the non-conductive substrate, the non-conductive substrate separating the encapsulation material from the anode and cathode terminations.

24. The circuit board of claim 23 wherein the first external conductive path allows an improvement in volumetric efficiency by allowing a larger capacitive element in the case than if the anode termination was electrically connected to the capacitive element through the case.

25. The circuit board of claim 22 further comprising minimizing volume of the case around the capacitive element relative to the volume of the capacitive element.

26. The circuit board of claim 25 wherein volume of the case is minimizing by minimizing wall thickness of the case by high precision molding and singulation of the case.

27. The circuit board of claim 22 further comprising a plurality of said capacitors.

28. The circuit board of claim 22 wherein the capacitive element comprises a solid pellet anode body, an embedded or welded wire partially in the anode body, a dielectric layer formed by oxidation of the anode body, and an electrolyte layer over the dielectric layer.

29. An electrical or electronic device comprising: a) a housing and a user interface; b) an electrical circuit board in the housing including at least one surface mount capacitor; c) the surface mount capacitor comprising a capacitive element including an anode and a cathode, an encapsulation material forming a case around the capacitive element except for an exposed portion of the anode, an electrically conductive planar substrate comprising anode and cathode terminations having surface mounting portions on a single exterior side of the case and to which the capacitive element is mounted, a first conductive path between the exposed portion of the anode and the anode termination comprising a first external conductive connection on a first external surface of the case, and a second conductive path between the cathode and the cathode termination comprising a second external conductive connection on a second external surface of the case.

30. The surface mount capacitor of claim 29 further comprising a non-conductive substrate, the anode and cathode terminations operatively connected to the non-conductive substrate, the non-conductive substrate separating the encapsulation material from the anode and cathode terminations.

31. The device of claim 29 further comprising a plurality of said capacitors.

32. The device of claim 29 wherein the capacitive element comprises a solid pellet anode body, an embedded or welded wire in the anode body, a dielectric layer formed by oxidation of the anode body, and an electrolyte layer over the dielectric layer.

33. A method of manufacturing a surface mount capacitor, comprising:
substantially encapsulating a capacitive element including an anode and a cathode while leaving an exposed portion of the anode;
forming a cathode termination and an anode termination on an insulating substrate separated from the capacitive element;
forming a first conductive path between the exposed portion of the anode and an anode termination, the first conductive path comprising a first external conductive connection on a first external surface of the capacitor;
forming a second conductive path between the cathode and a cathode termination, the second conductive path comprising a second external conductive connection on a second external surface of the capacitor.

34. The method of claim 33 wherein the second conductive path further comprises a conductive adhesive between the second external conductive connection and the cathode.

35. The method of claim 33 wherein the anode termination and the cathode termination are not formed from a lead frame.
